(19) United States
(12) Patent Application Publication
(10) Pub. No.: US 2010/0326369 A1
(43) Pub. Date: Dec. 30, 2010

(54) Pet toy

(76) Inventors: George Freeman, San Francisco, CA (US); Richard Shiu, San Francisco, CA (US)

Correspondence Address: CHRISTOPHER J. CAPELLI, 2 SUZANNE LANE, CHAPPAQUA, NY, 10514, US

(21) Appl. No.: 12/456,993

(22) Filed: Jun. 25, 2009

(51) Int. Cl. A01K 29/00

(52) U.S. Cl. 119/709; 119/707

(57) ABSTRACT

A pet toy is provided that includes an elongated body portion defining an inner cavity portion. The elongated body portion is provided with an exterior plush-like fabric material. A secondary pet toy, such as a dog bone, is disposed in the inner-cavity portion of the elongated body portion.

### FIELD OF THE INVENTION

The present invention relates to a pet toy, and more particularly to a pet toy containing a concealed dog bone.

### BACKGROUND OF THE INVENTION

Pets, such as, for example, cats and dogs, which spend the majority of their time indoors, are becoming increasingly popular. In addition, due to the increasingly busy schedules of their owners, such pets are spending an increasing amount of time alone indoors when their owners are not present. While having healthy and happy pets is an objective of virtually every pet owner, the ability of pet owners to exercise and play with their pets to keep them stimulated is sometimes limited due to a lack of time and energy on behalf of the pet owner.

Many different devices have been developed to assist pet owners in keeping their pets happy and healthy. Such devices can be seen in numerous pet stores and catalogs. Different types of balls, bones and other such toys can be purchased by the owner to be used by their pets for exercise and enjoyment. However, pets tend to quickly lose interest in such devices and thus, the pets do not benefit from exercise and enjoyment from such devices when they are not used by the pets.

Also, as pets become more and more popular, it is becoming more common for people to provide gifts not only for their pets but for the pets of others as well. Thus, it would be advantageous to provide a pet toy that is not only attractive to a pet, but to the pet owner as well.

The foregoing illustrates limitations known to exist in present pet toys. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

The present invention in an illustrative embodiment provides a pet toy including a forward portion simulating the head and front legs of a dog, a rear portion simulating the rear and hind legs of a dog, and an elongated body portion connecting the forward portion and the rear portion. The elongated body portion defines an inner-cavity portion in which a dog bone is disposed and concealed therewithin. Preferably, the elongated body portion defines an opening configured to receive the dog bone within the inner cavity portion of the elongated body portion.

### BRIEF DESCRIPTION OF THE DRAWINGS

The objects and features of the invention may be understood with reference to the following detailed description of an illustrative embodiment of the invention taken in conjunction with the accompanying drawings in which:

FIG. 1 illustrates a perspective view of the pet toy in accordance with an illustrative embodiment of the present invention;

FIG. 2 is a perspective view of the pet toy of FIG. 1 in an open configuration illustrating a bone which is concealed in the pet toy when in a closed configuration; and

FIGS. 3 and 4 illustrate use of the pet toy of FIG. 1 by a pet.

### DETAILED DESCRIPTION

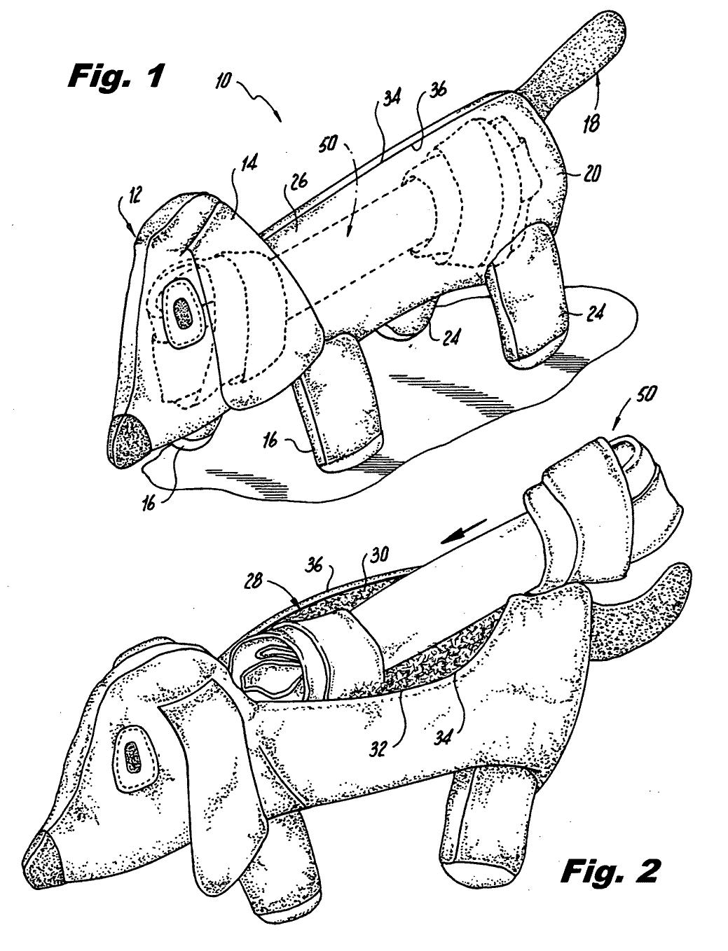

Turning now descriptively to the drawings, in which similar reference characters denote similar elements throughout the several views, FIG. 1 depicts a pet toy in accordance with an illustrative embodiment of the present invention, generally indicated by reference numeral 10.

With reference to FIG. 1, the pet toy 10 of the present invention is illustrated as an animal body including a forward portion 12 simulating the shape of the head 14 and front legs 16 of a dog and rear portion 18 simulating the shape of the rear 20 and hind legs 24 of a dog. A flexible, elongated, substantially cylindrical body portion 26 connects the forward portion 12 and rear portion 20 of the illustrated dog.

It is to be appreciated that while the pet toy 10 of the present invention is illustrated having the configuration of a dog in FIG. 1, the present invention is not to be understood to be limited thereto. For instance, the present invention pet toy 10 may be configured as virtually any type of animal, including a: cat, pig, cow, duck, chip monk, bird, lion and the like. It is additionally to be appreciated that the present invention is not to be understood to be limited to being configured as an animal body but may be configured to simulate the shape of any animate or inanimate body configuration capable of concealing a dog bone 50 therewithin (as described below), such as a: car; truck; train; house; tree; shoe; bone; etc.

Pet toy 10 is preferably fabricated to have an exterior plush-like fabric covering which is consists of a material, which if ingested by a pet will not cause harm to the pet. Examples of such a material include cotton, wool, felt or the like. Pet toy 10 may be fabricated from a unitary piece of covering material or may be fabricated from multiple pieces of materials each being sew or otherwise adhered to one another.

With reference now to FIG. 2, the inner cavity portion 28 of pet toy 10 is preferably filled with resilient filler material 30. Like the aforesaid fabric material used to configure the exterior body portion of pet toy 10, the resilient filler material preferably consists of a material, which if ingested by a pet will not cause harm to the pet.

As shown in FIGS. 1 and 2, a dog bone 50 is disposed in the inner cavity portion 28 of pet toy 10. It is appreciated that dog bone 50 consists of a material that can be safely chewed and ingested by pet (e.g., a dog) and may be any type of known bone used for chewing by such pets, including rawhide bones, sterilized bones, meaty bones and even bones fabricated from pressed foods particles such as oatmeal and other grain type products. It is to be appreciated that in alternative embodiments of the present invention pet toy 10, dog bone 50 may be replaced with virtually any type of secondary pet toy capable of being disposed in the inner cavity portion 28, such as a plastic toy configured to make squeaky noises when chewed upon by a pet.

With reference now to FIG. 2, an opening 32 is formed along the body portion 26 of the pet toy 10 dimensioned to accommodate insertion of bone 50 into the inner cavity portion 28 of pet toy 10. The opening 32 is defined by opposing ends 34, 36 formed or cut along the body portion 26. Once the dog bone 50 is inserted in the inner cavity portion 28 (as shown in FIG. 1), the opposing ends 34, 36 are brought together so as to be adhered together through known means of doing so including through sewing and other known adherence means, such as heat or glue bonding. It is to further be appreciated that temporary means (e.g., VELCRO™, buttons, clasps and the like) may be employed for adhering the open ends 34, 36 together enabling a person to reinsert a dog bone 50 after it was caused to be removed from the inner cavity portion 28 of pet toy 10.

It is also to be appreciated that pet toy 10 may be provided to a person with or without a dog bone 50 inserted within the inner-cavity 28 of pet toy 10. A noted advantage of enabling a person to insert a dog bone 50 of their choosing is that some dogs may only chew on certain types of dog bones (e.g., some dog bones may be dangerous to certain types of dogs).

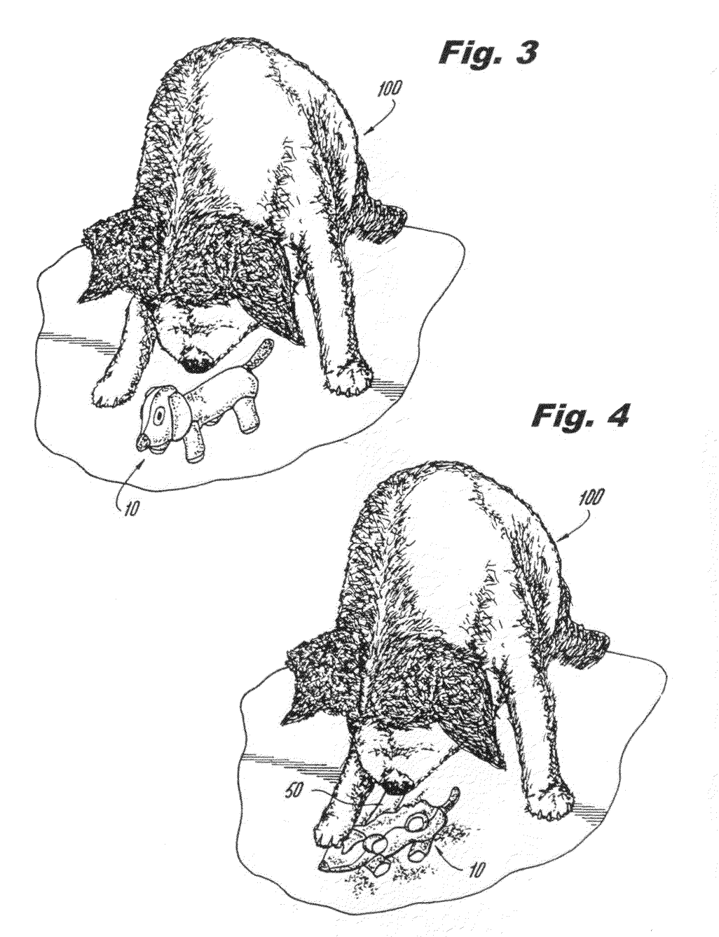

With reference now to FIGS. 3 and 4, use (e.g., play) of the present pet toy 10 by an animal 100 such as a dog is illustrated and briefly discussed.

As shown in FIG. 3, pet toy 10 having a bone 50 disposed therein is first presented to a dog 100, which dog 100 will investigate what it is and will most likely proceed to engage in play with pet toy 10. It is noted that depending upon the type of bone 50 disposed in pet toy 10, the dog 100 may detect the scent of the bone 50 which will only serve to heighten the dogs 100 play with pet toy 10.

As the dog 100 continues to play with pet toy 50 in its mouth, as is typical with dogs, continued play of the dog 100 will cause the inner cavity 28 of pet toy 10 to be exposed, preferably through the reopening of open ends 34, 36 causing dog 100 to gain direct access the dog bone 50 disposed therewithin. The dog 100, in a most likely excited state, will remove the bone 50 from the dog toy 100 and will afterwards concentrate its playful attention on the removed dog bone 50.

It is noted if the pet toy 50 was formed with open ends 34, 36 having temporary adherence means (e.g., VELCRO™, buttons, clasps and the like) then a person may reinsert the same or another dog bone 50 into the inner-cavity 28 of pet toy 10 so as to repeat the above.

While only an illustrated embodiment of the present invention has been disclosed for purposes of illustration, it is to be appreciated (as discussed above) that many modifications and variations could be made thereto. It is intended to cover all of those modifications and variations which fall within the scope of the present invention, as defined by the following claims.

What is claimed is:

1. A pet toy comprising:
a forward portion simulating the head and front legs of a dog,
a rear portion simulating the rear and hind legs of a dog;
an elongated body portion connecting said forward portion and said rear portion, said elongated body portion defining an inner-cavity portion; and
a dog bone disposed in said inner-cavity portion of said elongated body portion.

2. The pet toy of claim 1 wherein said elongated body portion defines an opening configured to receive said dog bone into said inner cavity portion of said elongated body portion.

3. The pet toy of claim 2 wherein said opening is provided with an attachment mechanism permitting said opening to be selectively opened and closed by a user.

4. The pet toy of claim 3 wherein said attachment mechanism consists of VELCRO.

5. The pet toy of claim 1 wherein each of said forward portion, rear portion and elongated body portion is fabricated from a plush-like fabric material.

6. The pet toy of claim 1 wherein said inner cavity portion of said elongated body portion is provided with resilient filler material.

7. The pet toy of claim 1 wherein said dog bone consists of rawhide.

8. A pet toy comprising:
an elongated body portion defining an inner cavity portion and having an exterior portion provided with plush-like fabric material; and
a secondary pet toy disposed in said inner-cavity portion of said elongated body portion.

9. The pet toy of claim 8 wherein said secondary pet toy is a dog bone.

10. The pet toy of claim 9 wherein said dog bone consists of raw hide.

11. The pet toy of claim 8 wherein said elongated body portion includes an opening mechanism configured to permit insertion of said secondary pet toy.

12. The pet toy of claim 8 wherein said elongated body portion is configured as an animal.

13. The pet toy of claim 12 wherein said animal is a dog having a forward portion simulating the head and front legs of a dog, a rear portion simulating the rear and hind legs of a dog; and an elongated body portion connecting said forward portion and said rear portion.

14. The pet toy of claim 8 wherein said inner cavity portion of said elongated body portion is provided with resilient filler material.
